(19) United States
(12) Patent Application Publication
(10) Pub. No.: US 2013/0100953 A1
(43) Pub. Date: Apr. 25, 2013

(54) In Band Signaling in Next Generation-Multicast Virtual Private Network Using Receiver Driven Resource Reservation Protocol-Traffic Engineering Point-To-Multipoint

(71) Applicant: Futurewei Technologies, Co., Plano, TX (US)

(72) Inventors: Renwei Li, Fremont, CA (US); Qianglin Quintin Zhao, Boxborough, MA (US)

(73) Assignee: FUTUREWEI TECHNOLOGIES, CO., Plano, TX (US)

(21) Appl. No.: 13/659,621

(22) Filed: Oct. 24, 2012

Related U.S. Application Data
(60) Provisional application No. 61/550,804, filed on Oct. 24, 2011.

(51) Int. Cl. H04L 12/56

(52) U.S. Cl. 370/390

(57) ABSTRACT

A method executed by a processor in a network node positioned inside a Multiprotocol Label Switching (MPLS) core network for establishing a Point to Multipoint (P2MP) Virtual Private Network (MVPN), comprising receiving a Protocol-Independent Multicast (PIM) Join message from a node outside the MPLS core network, wherein the PIM Join message comprises a source VPN identifier (ID) and propagating the source VPN ID across a P2MP Label Switched Path (LSP) established in the MPLS core network with in-band signaling using Resource Reservation Protocol-Traffic Engineering (RSVP-TE).

### CROSS-REFERENCE TO RELATED APPLICATIONS

The present application claims the benefit of U.S. Provisional Patent Application No. 61/550,804 filed Oct. 24, 2011 by Renwei Li, et al. and entitled “In Band Signaling in Next Generation-Multicast Virtual Private Network Using Receiver Driven Resource Reservation Protocol Traffic Engineering Point-to-Multipoint,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Modern communications and data networks are comprised of nodes that transport data through the network. The nodes may include routers, switches, bridges, or combinations thereof that transport the individual data packets or frames through the network. Some networks may offer data services that forward data frames from one node to another node across the network without using pre-configured routes on intermediate nodes. Other networks may forward the data frames from one node to another node across the network along pre-configured or pre-established paths. Some networks implement Virtual Private Networks (VPNs), a scheme that logically interconnects remote (and often geographically separate) networks through public communication infrastructures, such as the Internet, or other core networks. Multicast VPN (MVPN) is a technology to deploy multicast services across existing VPNs or as part of a transportation infrastructure. A mechanism, such as a Protocol-Independent Multicast (PIM), may be used to carry MVPN multicast routing information and multicast traffic and/or Point-to-Multi-Point (P2MP) traffic (at a data plane) and enable the flow of multicast traffic and/or P2MP traffic from the sources to the receivers.

A MVPN may be established using a core network, such as a Multiprotocol Label Switching (MPLS) core network, also referred to herein as a MPLS core. MPLS is a mechanism that directs data from one network node to the next based on short path labels instead of longer network addresses to avoid complex lookups in an address based routing table. The labels may identify virtual links (paths) between distant nodes rather than endpoints. In MPLS, packets of various network protocols, such as Internet Protocol (IP), may be encapsulated. The MVPN may be established to allow an enterprise to transparently interconnect a VPN across the MPLS core. As such, the MPLS core may serve as an overlay network for the MVPN, which may simplify MVPN control plane messaging and data plane packet forwarding.

A P2MP Label Switched Path (LSP) may be a shared MPLS tree that defines a plurality of paths used by a plurality of provider edge (PE) routers or nodes within the same MVPN domain to transport control messages and P2MP data between one another. The P2MP LSP may serve as a P2MP distribution tree in a network and may be receiver or sender initiated and Quality-of-Service (QoS) demanding. Setting up the P2MP LSP efficiently in the network may be challenging due to multiple needed exchanges between the different components involved. Resource Reservation Protocol-Traffic Engineering (RSVP-TE) may be used in the setup of the multicast distribution tree to provide the QoS service required. However, RSVP-TE may need the knowledge of the locations of all receivers for the tree prior to the tree setup. Thus, a receiver discovery protocol may also be needed, such as a Border Gateway Protocol (BGP), to discover all the involved receivers. Further, a substantial number of PATH and RESV messages, as defined in the RSVP-TE protocol, may be exchanged during the tree setup, which may consume substantial network resources (e.g., bandwidth) and thus negatively affect performance.

### SUMMARY

In one example embodiment, the disclosure includes a method executed by a processor in a network node positioned inside a Multiprotocol Label Switching (MPLS) core network for establishing a Point to Multipoint (P2MP) Virtual Private Network (MVPN), comprising receiving a Protocol-Independent Multicast (PIM) Join message from a node outside the MPLS core network, wherein the PIM Join message comprises a source VPN identifier (ID) and propagating the source VPN ID across a P2MP Label Switched Path (LSP) established in the MPLS core network with in-band signaling using Resource Reservation Protocol-Traffic Engineering (RSVP-TE).

In another example embodiment, the disclosure includes a computer program product in a leaf node along a label switched path (LSP) in a Multiprotocol Label Switching (MPLS) core network, the computer program product executable by a processor, the computer program product comprising computer executable instructions stored on a non-transitory computer readable medium that when executed by the processor cause the leaf node to perform the following receive a Protocol-Independent Multicast (PIM) Join message from a node outside the MPLS core network, wherein the PIM Join message comprises a source VPN identifier (ID) and propagate the source VPN ID across a P2MP Label Switched Path (LSP) established in the MPLS core network with in-band signaling using Resource Reservation Protocol-Traffic Engineering (RSVP-TE).

In another example embodiment, the disclosure includes a network node on a Label Switched Path (LSP) in a Multiprotocol Label Switching (MPLS) core network, comprising a receiver configured to receive a Protocol-Independent Multicast (PIM) Join message from a node outside the MPLS core network, wherein the PIM message comprises a source VPN identifier (ID), a transmitter configured to transmit data to other nodes in the MPLS core network, and a processor coupled to the receiver and the transmitter, wherein the processor is configured to create extract the source VPN ID from the PIM Join message and cause the transmitter to propagate the source VPN ID across a P2MP LSP established in the MPLS core network with in-band signaling using Resource Reservation Protocol-Traffic Engineering (RSVP-TE).

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 depicts one embodiment of a label switched system, where a plurality of P2P LSPs and P2MP LSPs may be established between at least some of the components.

FIG. 2 is a schematic diagram illustrating a sender-driven P2MP LSP creation scheme for an MVPN using RSVP-TE signaling.

FIG. 3 is a schematic diagram illustrating a receiver-driven P2MP LSP creation scheme using RSVP-TE signaling.

FIG. 4 is a schematic diagram of a scheme for network to network mapping for a Next Generation (NG) MVPN using RSVP TE P2MP.

FIG. 5 is a schematic diagram of a scheme for network to network mapping for a NG MVPN using RD-RSVP TE according to a disclosed example embodiment of the disclosure.

FIG. 6 is a flowchart of a method for network mapping from PIM to RD-RESVP-TE to PIM according to an exemplary embodiment of the disclosure.

FIG. 7 is a schematic diagram that illustrates an example embodiment of a network unit, which may be any device that transports and processes data through the network.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein is a scheme to use in-band signaling to setup a MVPN across an MPLS domain or core network. In an exemplary embodiment, the scheme may comprise a receiver driven (RD) RSVP-TE and may provide network mapping from a PIM to the RD RSVP-TE and back to the PIM. The edge or leaf nodes of the MPLS core network may extract the source VPN ID and the group ID from the PIM message and create a PATH message that includes the source VPN ID and the group ID, which may be encoded as part of the P2MP ID or tunnel ID field in the RSVP-TE PATH message. In another exemplary embodiment, if the PIM message comprises the source VPN ID and the rendezvous point ID, the leaf node may extract these IDs and encode the source VPN ID and the rendezvous point ID as part of the P2MP ID or tunnel ID field in the RSVP-TE PATH message. The PATH message may be forwarded to the root node of the MPLS core network. The root node may return a RESV message that contains the source VPN ID, either the group ID or the rendezvous point ID, and an upstream label to the leaf node. The PATH message and the RESV message may be forwarded to the root node or the leaf node via a branch node. The disclosed scheme avoids the need for out-of-band signaling as the source VPN ID and the group ID or the source VPN ID and the rendezvous point ID from the PIM message are propagated through the RD-RSVP TE P2MP system. Also, traffic between the root node and the branch nodes may be reduced because the disclosed scheme is receiver driven.

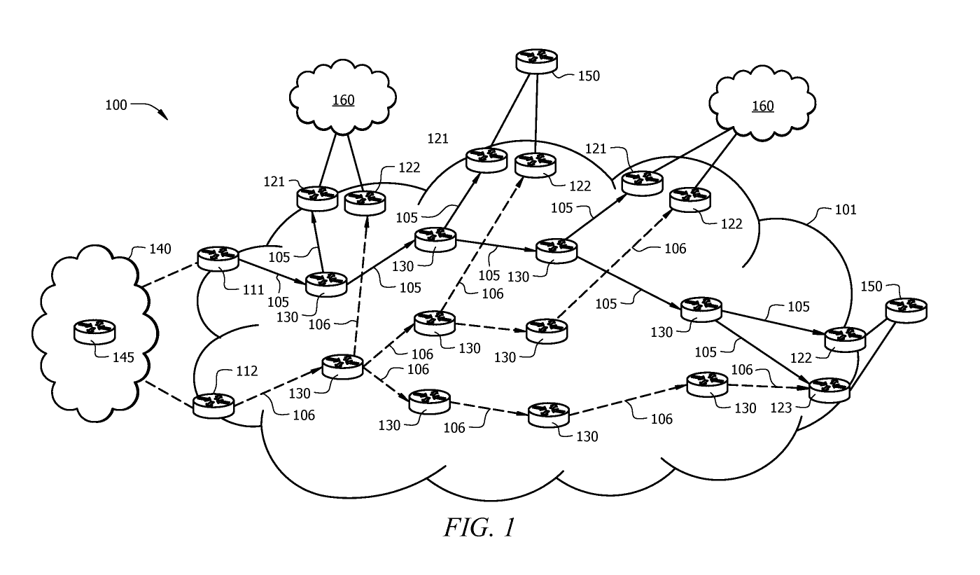

FIG. 1 depicts one embodiment of a label switched system 100, where a plurality of P2P LSPs and P2MP LSPs may be established between at least some of the components. The P2P LSPs and P2MP LSPs may be used to transport data traffic, e.g., using packets and packet labels for routing. The label switched system 100 may comprise a label switched network 101, which may be a packet switched network that transports data traffic using packets or frames along network paths or routes. The packets may route or switch along the paths, which a label switching protocol, such as MPLS or generalized MPLS (GMPLS), may establish.

The label switched network 101 may comprise a plurality of edge nodes, including a first ingress node 111, a second ingress node 112, a plurality of first egress nodes 121, and a plurality of second egress nodes 122. When a P2MP LSP in the label switched network 101 comprises ingress and egress edge nodes, the first ingress node 111 and second ingress node 112 may be referred to as root nodes or head nodes, and the first egress nodes 121 and second egress nodes 122 may be referred to as leaf nodes or tail end nodes. Additionally, the label switched network 101 may comprise a plurality of internal nodes 130, which may communicate with one another and with the edge nodes. In addition, the first ingress node 111 and the second ingress node 112 may communicate with a source node 145 at a first external network 140, such as an Internet Protocol (IP) network, which may be coupled to the label switched network 101. Furthermore, first egress nodes 121 and second egress nodes 122 may communication with destination nodes 150 or other networks 160. As such, the first ingress node 111 and the second ingress node 112 may transport data, e.g., data packets, from the external network 140 to destination nodes 150.

In an embodiment, the edge nodes and internal nodes 130 (collectively, network nodes) may be any devices or components that support transportation of the packets through the label switched network 101. For example, the network nodes may include switches, routers, or various combinations of such devices. Each network node may comprise a receiver that receives packets from other network nodes, a processor or other logic circuitry that determines which network nodes to send the packets to, and a transmitter that transmits the packets to the other network nodes. In some embodiments, at least some of the network nodes may be label switch routers (LSRs), which may be configured to modify or update the labels of the packets transported in the label switched network 101. Further, at least some of the edge nodes may be label edge routers (LERs), which may be configured to insert or remove the labels of the packets transported between the label switched network 101 and the external network 140.

The label switched network 101 may comprise a first P2MP LSP 105, which may be established to multicast data traffic from the first external network 140 to the destination nodes 150 or other networks 160. The first P2MP LSP 105 may comprise the first ingress node 111 and at least some of the first egress nodes 121. The first P2MP LSP 105 is shown using solid arrow lines in FIG. 1. Typically, to protect the first P2MP LSP 105 against link or node failures, the label switched network 101 may comprise a second P2MP LSP 106, which may comprise the second ingress node 112 and at least some of the second egress nodes 122. The second P2MP LSP 106 is shown using dashed arrow lines in FIG. 1. Each second egress node 122 may be paired with a first egress node 121 of the first P2MP LSP 105. The second P2MP LSP 106 may also comprise some of the same or completely different internal nodes 130. The second P2MP LSP 106 may provide a backup path to the first P2MP LSP 105 and may be used to forward traffic from the first external network 140 to the first P2MP LSP 105 or second P2MP LSP 106, e.g., to egress node 123, when a network component of P2MP LSP 105 fails.

When a component of P2MP LSP 105 fails, rerouting traffic via a corresponding second P2MP LSP 106 may cause a delay in traffic delivery. Even when the second P2MP LSP 106 carries the same traffic as the first P2MP LSP 105, when the network component of the first P2MP LSP 105 fails, the delay for the first P2MP LSP 105 or second P2MP LSP 106 to determine the failure and switch to a backup path for transmitting the traffic may be long. Such delay may not be acceptable in some systems, e.g., for real time services such as IPTV.

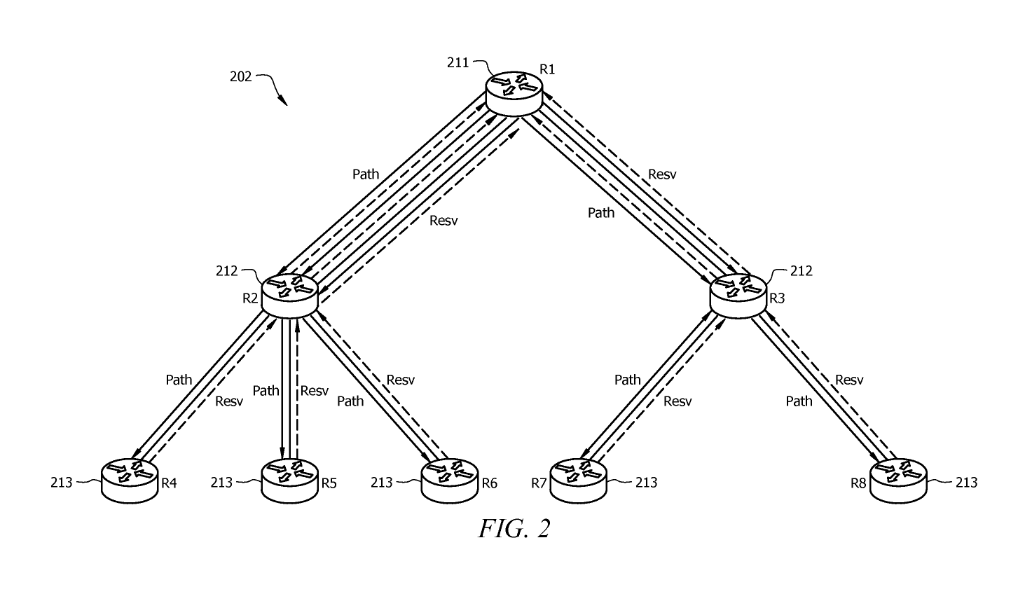

FIG. 2 is a schematic diagram illustrating a sender-driven P2MP LSP creation scheme 202 for an MVPN using RSVP-TE signaling. The scheme 202 may be implemented in an MPLS network, which may be any network configured to implement MPLS and transport IP packets or similar packets. The MPLS network may comprise a plurality of nodes 211, 212, 213, which may be configured to transport data packets in the MPLS network. For example, the nodes may include routers, switches, bridges, or combinations thereof. The nodes 211, 212, 213 may comprise a plurality of leaf nodes 213 (labeled R4, R5, R6, R7, and R8) and a root node 211 (labeled R1) coupled to the leaf nodes 213 directly or via one or more intermediate (or branch) nodes 212 (labeled R2 and R3). The root node 211, the intermediate nodes 212, and the leaf nodes 213 may be configured to forward packets using labels in the packets based on the MPLS protocol. The root node 211 may serve as the root of a P2MP LSP tree and the leaf nodes 213 may be the leaves of the tree. The leaf nodes 213 may be coupled to a plurality of corresponding external networks (not shown), which may be IP networks or any other type of communications networks configured to exchange data (e.g., in the form of packets) via the MPLS network.

In order to create a P2MP LSP for a MVPN using RSVP-TE, the root node 211 may send a RSVP-TE PATH message, as defined in Internet Engineering Task Force (IETF) Request for Comments (RFC) 3209 entitled “RSVP-TE Extensions to RSVP for LSP Tunnels” by D. Awduche et al., which is incorporated herein by reference as if reproduced in its entirety, to each leaf node 213 to join the P2MP LSP. The PATH message may be forwarded in the MPLS network via the branch nodes 212. The PATH messages are indicated by solid arrows from the root node 211 to the branch nodes 212 and from the branch nodes to the leaf nodes 213. The root node 211 must send a Path message to each leaf node 213 that is invited to join the P2MP LSP. After receiving the PATH message, each leaf node 213 may return an RSVP-TE RESV message, as defined in IETF RFC 3209, to the root node 211. As such, sub-LSPs (paths or branches of the LSP tree) may be established along the network nodes that forward the PATH and RESV message from each of the root node 211 to the leaf nodes 213. The PATH message and similarly the returned RESV message may comprise a VPN ID, a multicast source address, a group address and a root address in a SESSION object, as defined in the RSVP protocol. The VPN ID may indicate the VPN of an external network (not shown). The multicast source address may indicate the network address (e.g., IP or Media Access Control (MAC) address), of the source (not shown). The group address may be a network address (e.g., IP address) of a group of nodes that belong to a multicast domain or group. The root address may be a network address (e.g., IP or MAC address) of the root node 211.

Additionally, the PATH message for each leaf node 213 may indicate an upstream label corresponding to that leaf node 213, which may be used for multicast upstream traffic in the established P2MP LSP. The returned RESV message for each leaf node 213 may also indicate a downstream label corresponding to that leaf node 213, which may be used for multicast downstream traffic in the established P2MP LSP. The upstream labels for each leaf node 213 may be assigned by that leaf node 213 and the downstream label for each leaf node 213 may be assigned by the root node 211. At least some of the information sent in the PATH and RESV messages may be maintained in the leaf nodes 213 and the root node 211 (e.g., in a local forwarding or binding table) to bind and forward the incoming multicast traffic from the VPN at the external networks on the established paths of the P2MP LSP. The incoming multicast packets may comprise information that may be matched to the locally maintained information at the leaf nodes 213 and the root node 211 to properly forward the multicast traffic along the P2MP LSP. The P2MP LSP creation may be triggered by MVPN configuration on the root node 211.

As shown in FIG. 2, the root node 211 sends a PATH message to branch node R2 for each of leaf nodes R4, R5, and R6 and receives from branch node R2 a RESV message from each of leaf nodes R4, R5, and R6. Similarly, root node 211 sends a PATH message to branch node R3 for each of leaf nodes R7 and R8 and receives a RESV message from branch node R3 for each of leaf nodes R7 and R8. Thus, root node 211 sends five separate PATH messages and receives five separate RESV messages in order to create a P2MP LSP with the five leaf nodes R4, R5, R6, R7, and R8. As shown, this method for creating a P2MP LSP tree may not be efficient if there are a great number of leaf nodes.

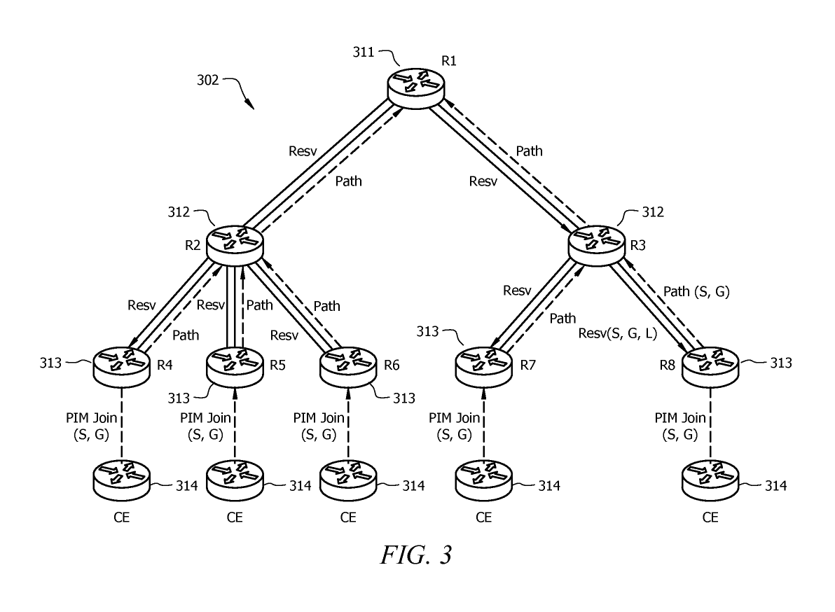

FIG. 3 is a schematic diagram illustrating a receiver-driven P2MP LSP creation scheme 302 using RSVP-TE signaling. The scheme 302 may be implemented in an MPLS network, which may be any network configured to implement MPLS and transport IP packets or similar packets. The MPLS network may comprise a plurality of nodes 311, 312, and 313 which may be configured to transport data packets in the MPLS network. For example, the nodes may include routers, switches, bridges, or combinations thereof. Nodes 314 of an external network (not shown) may be coupled to the leaf nodes 313 as shown. The nodes may comprises a root node 311, a plurality of branch nodes 312, a plurality of leaf nodes 313, and a plurality of customer edge (CE) nodes 314. The root node 311 may be substantially similar to root node 211, the branch nodes 312 may be substantially similar to branch nodes 212, and the leaf nodes 313 may be substantially similar to leaf nodes 213. The CE nodes 314 may be positioned at the edge of external networks (not shown) and coupled to the leaf nodes 313 as shown. The CE nodes 314 may forward multicast data or packets from and to user equipment (not shown) in the external networks via the leaf nodes 313.

The PATH message for each leaf node 313 may indicate a downstream label corresponding to that leaf node 313, which may be used for multicast downstream traffic in the established P2MP LSP. The returned RESV message for each leaf node 313 may also indicate an upstream corresponding to that leaf node 313, which may be used for multicast upstream traffic in the established P2MP LSP. The downstream labels for each leaf node 313 may be assigned by that leaf node 313 and the upstream label for all the leaf nodes 313 may be assigned by the branch node 312. The downstream labels for each branch node 312 may be assigned by that branch node 312 and the upstream label for all the branch nodes 312 may be assigned by the root node 311. At least some of the information sent in the PATH and RESV messages may be maintained in the leaf nodes 313, the branch nodes 312, and the root node 311 (e.g., in a local forwarding or binding table) to bind and forward the incoming multicast traffic from the VPN at the external networks (not shown) to which the CE nodes 314 are connected via the established paths of the P2MP LSP. The incoming multicast packets may comprise information that may be matched to the locally maintained information at the leaf nodes 313, the branch nodes 312, and the root node 311 to properly forward the multicast traffic along the P2MP LSP.

As shown in FIG. 3, at each leaf node 313, one PATH message may be sent upstream to the branch node 312. At every branch node 312, multiple PATH messages may be merged as one to be sent upstream to the root node 311. The root node 311 may receive a single PATH message from each branch node 312 rather than a PATH message from each of the leaf nodes 313. For each PATH message received by the root node 311, the root node 311 may send a RESV message downstream to each branch node 312. Each branch node 312 may replicate the RESV message and may send a RESV message to each of the leaf nodes 313. As compared to the scheme 202, scheme 302 may result in less traffic between the root node 311 and the branch nodes 312 than the traffic between root node 211 and the branch nodes 212 in scheme 202.

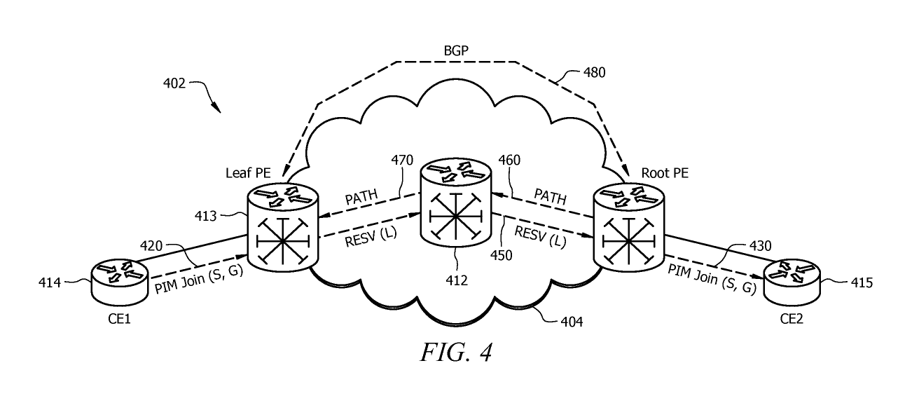

FIG. 4 is a schematic diagram of a scheme 402 for network to network mapping for a Next Generation (NG) MVPN using RSVP TE P2MP. The scheme 402 may be implemented in an MPLS network 404, which may be any network configured to implement MPLS and transport IP packets or similar packets. The MPLS network 404 may comprise a plurality of nodes 411, 412, and 413 which may be configured to transport data packets in the MPLS network 404. For example, the nodes 411, 412, 413 may include routers, switches, bridges, or combinations thereof. The nodes 411, 412, 413 may comprise a root node 411, a branch node 412, and a leaf node 413. Other leaf nodes may be connected to the branch node 412, but are not shown for clarity of explanation. The root node 411 may be substantially similar to the root node 211, the branch node 412 may be substantially similar to the branch nodes 212, and the leaf node 413 may be substantially similar to the leaf nodes 213.

Additionally, customer edge (CE) nodes 414, 415 may be positioned at the edge of external networks (not shown) and coupled to the leaf provider edge (PE) node 413 and the root node 411 as shown. The CE nodes 414, 415 may forward multicast data or packets from and to user equipment (not shown) in the external networks via the leaf node 413 and/or root node 411. A CE1 node 414 may join a NG MVPN originating at CE2 node 415. To join, the CE1 node 414 may send a PIM Join message 420, as defined in IETF RFC 4601, 3973, 5015, or 3569, all of which are incorporated herein by reference as if reproduced in their entirety, to leaf node 413. The PIM Join message 420 may comprises a source identifier (S) and a group identifier (G). The root node 411 may send a PATH message 460 to branch node 412 which may send a PATH message 470 to leaf node 413. The leaf node 413 may reply and send a RESV message 440 to branch node 412 which may send a RESV message 450 to root node 411. The RESV messages 440, 450 may comprise a label (L). The messages 440, 450, 460, 470 may create a network path for P2MP traffic from CE2 node 415 to CE1 node 414. The root node 411 may send the PIM Join message 430 to CE2 node 415. The PIM Join message 430 may be substantially similar to the PIM message 420 and may comprise the S and G identifiers. The S and G identifiers may not be transmitted through the MPLS network 404. To map the PIM Join message 420 across the MPLS network 404, BGP messages 480, as defined in IETF RFC 4271, which is incorporated herein by reference as if reproduced in its entirety, may be exchanged between the leaf node 413 and the root node 411. The BGP messages 480 may propagate the S and G information for the PIM messages 420 and 430. The BGP messages 480 may be considered out-of-bounds signaling since they do not utilize the RESV and PATH messages of the MPLS network 404 and may introduce additional complexity and overhead into the scheme 402.

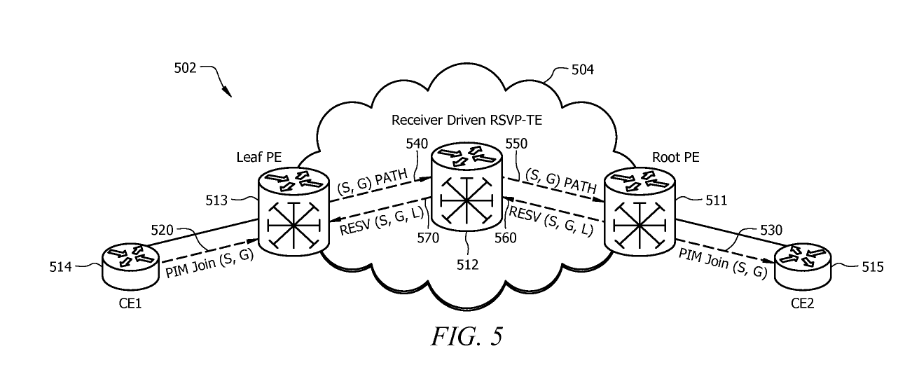

FIG. 5 is a schematic diagram of a scheme 502 for network to network mapping for a NG MVPN using a Receiver Driven (RD) RSVP TE according to a disclosed example embodiment. The scheme 502 may be implemented in an MPLS core network 504, which may be any network configured to implement MPLS and transport IP packets or similar packets. MPLS core network 504 may be substantially similar to MPLS network 404. The MPLS core network 504 may comprise a plurality of nodes 511, 512, and 513 which may be configured to transport data packets in the MPLS core network 504. For example, the nodes 511, 512, 513 may include routers, switches, bridges, or combinations thereof. The nodes 511, 512, 513 may comprise a root node 511, a branch node 512, and a leaf node 513. Other leaf nodes may be connected to branch node 412, but are not shown for clarity of explanation. The root node 511 may be substantially similar to root node 211, the branch node 512 may be substantially similar to branch nodes 212, and the leaf node 513 may be substantially similar to leaf nodes 213. CE nodes 514 and 515 may be positioned at the edge of external networks (not shown) and coupled to the leaf PE node 513 and the root node 511 as shown. CE1 node 514 may be substantially similar to CE1 node 414 and CE2 node 515 may be substantially similar to CE2 node 415.

CE1 node 514 may join a NG MVPN originating at CE2 node 515. To join the NG MVPN, the CE1 node 514 may send a PIM Join message 520 to the leaf node 513. The PIM Join message 520 may comprises a source identifier (S) and a group identifier (G). The leaf node 513 may send a PATH message 540 to branch node 512 which may send a PATH message 550 to the root node 511. The PATH message 550 may be substantially similar to the PATH message 540. The PATH messages 540 and 550 may comprise the VPN source address (S) (e.g., an IP source address 10.1.1.1) and a group address (G) (e.g., an IP group address 0.0.0.0). The VPN source address (S) and the VPN group address (G) may be encoded by the leaf node 513 as part of the P2MP ID or the tunnel ID in the RSVP-TE PATH message. The leaf node 513 may map the VPN source address and the VPN group address from the PIM Join message from CE1 node 515. The root node 411 may return a RESV message 560 to branch node 512 which may send a RESV message 570 to leaf node 513. The RESV messages 560 and 570 may comprise the VPN source address (S), the VPN group address (G), and a downstream label (L). As with the PATH message, the VPN source address (S) and the VPN group address (G) may be encoded in the RESV message as part of the P2MP ID or tunnel ID. The MVPN may be associated with a VPN ID and may be bound to a set of corresponding downstream and upstream labels corresponding to the root node 511, the branch node 512, and the leaf node 513.

After the P2MP LSP is established, the root node 511, the branch node 512, and the leaf node 513 may maintain the bindings between the corresponding MVPN and the corresponding MPLS labels (downstream and upstream labels). The binding information for each leaf node 513 (and similarly the root node 511 and branch node) may be maintained in a corresponding local MPLS binding table (not shown) for each of the nodes 511, 512, and 513. P2MP data may be forwarded over the P2MP LSP, which may serve as a P2MP LSP. The MPLS binding table for the leaf node 513 may comprise a downstream label and an upstream label assigned to each branch node 512 and leaf node 513, a next hop (NHOP) address or indicator that indicates the next hop in the sub-LSP or branch for each node 512 and 513, and a VPN ID, which may indicate the corresponding VPN of the leaf node 513.

In the case of PIM messages encoded in the form of (S,*,RP), the VPN source address (S) and the rendezvous point (RP) may be encoded in the RSVP-TE PATH and RESV messages as part of the P2MP ID or the tunnel ID.

The disclosed in-band signaling in NG-MVP path creation scheme 502 using a receiver driven RSVP-TE P2MP may improve tree setup time and improve network efficiency, utilization, cost, and scalability. For example, a data packet may arrive on root node 511 from source node CE2 515. Using a local MPLS binding table, root node 511 may encapsulate the packet with its assigned upstream label (e.g., 101), the source IP address (S), and the group IP address (G), and forward the packet to the indicated next hop (branch node 512) over the P2MP LSP. The packet received at root node 511 may comprise the source IP address (S), a group IP address (G), a P2MP LSP ID, the tunnel ID, the VPN ID, or combinations thereof. When the branch node 512 receives the packet, branch node 512 may swap the label with a downstream label for each of the next hops (using a local MPLS binding table), and then forward the packet to the next hops. The steps may be repeated at each next hop until the downstream leaf node 513 receives the packet. The leaf node 513 may then forward the packets (after removing the labels) to the MVPN in CE1 node 514 in the external network.

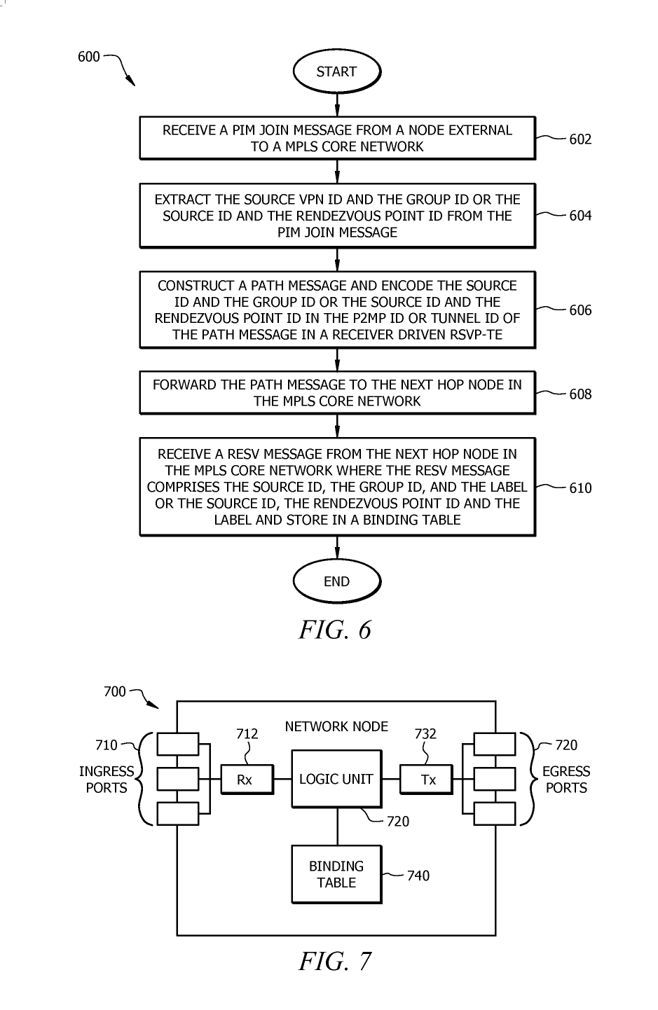

FIG. 6 is a flowchart of a method 600 for network mapping from PIM to RD-RESVP-TE to PIM according to an exemplary embodiment of the disclosure. The method 600 may begin at block 602 where a leaf node in a MPLS core network receives a PIM Join message from a node external to the MPLS core network. The PIM Join message may be a request to join a MVPN. At block 604, the leaf node may extract the source VPN I and the group ID or extract the source VPN ID and the rendezvous point ID from the PIM Join message. At block 606, the leaf node may construct a PATH message and encode the source VPN ID and the group ID or the source VPN ID and the rendezvous point ID in the P2MP ID or tunnel ID field of the PATH message in a RD-RSVP-TE scheme. At block 608, the leaf node may forward the PATH message to the next hop node in the MPLS core network. The next hop node may be a branch node or a root node. At block 610, the leaf node may receive a RESV message from the next hop node in the MPLS core network where the RESV message may comprise the source VPN ID, the group ID, and a label or the source VPN ID, the rendezvous point ID, and the label and the leaf node may store this information in a binding table, after which the method 600 may end.

FIG. 7 illustrates an example embodiment of a network node 700, which may be any device that transports and processes data through the network. For instance, the network node 700 may implement the scheme 502 method 600 for network to network mapping for a NG MVPN using RD-RSVP TE. The network node 700 may comprise one or more ingress ports or units 710 coupled to a receiver (Rx) 712 for receiving signals and frames/data from other network components. The network node 700 may comprise a logic unit 720 to determine which network components to send data to. The logic unit 720 may be implemented using hardware, software, or both. The logic unit 720 may be implemented as one or more central processing unit (CPU) chips, or may be part of one or more application-specific integrated circuits (ASICs) or digital signal processors (DSPs). The logic unit 720 may comprise one or more processors and one or more of the processors may be multi-core processors. The network node 700 may also comprise one or more egress ports or units 730 coupled to a transmitter (Tx) 732 for transmitting signals and frames/data to the other network components. The network node 700 may also comprise a MPLS binding table 740 that may maintain and store the binding information for the network node 700 to bind and forward the incoming multicast traffic from the VPN at the external networks on the established paths of the P2MP LSP. The components of the network node 700 may be arranged as shown in FIG. 7.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 7 percent, . . . , 70 percent, 71 percent, 72 percent, . . . , 97 percent, 96 percent, 97 percent, 98 percent, 99 percent, or 100 percent. Moreover, any numerical range defined by two R numbers as defined in the above is also specifically disclosed. The use of the term about means ±10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

We claim:

1. A method executed by a processor in a network node positioned inside a Multiprotocol Label Switching (MPLS) core network for establishing a Point to Multipoint (P2MP) Virtual Private Network (MVPN), comprising:
receiving a Protocol-Independent Multicast (PIM) Join message from a node outside the MPLS core network, wherein the PIM Join message comprises a source VPN identifier (ID); and
propagating the source VPN ID across a P2MP Label Switched Path (LSP) established in the MPLS core network with in-band signaling using Resource Reservation Protocol-Traffic Engineering (RSVP-TE).

2. The method of claim 1, wherein the network node encodes the source VPN ID in a PATH message that is forwarded to a root node in the MPLS core network.

3. The method of claim 2, wherein the source VPN ID is encoded in a P2MP ID field or a tunnel ID field in the PATH message.

4. The method of claim 1, wherein the PIM Join message further comprises a group ID that is propagated across the P2MP LSP established in the MPLS core network with in-band signaling using RSVP-TE.

5. The method of claim 1, wherein the PIM Join message further comprises a rendezvous point (RP) ID that is propagated across the P2MP LSP established in the MPLS core network with in-band signaling using RSVP-TE.

6. The method of claim 1, further comprising receiving a RESV message forwarded from a root node in the MPLS core network, wherein the RESV message comprises the source ID and an upstream label assigned by the root node.

7. The method of claim 1, wherein the PATH message comprises a downstream label assigned by the network node.

8. In a leaf node along a Label Switched Path (LSP) in a Multiprotocol Label Switching (MPLS) core network, a computer program product executable by a processor, the computer program product comprising computer executable instructions stored on a non-transitory computer readable medium that when executed by the processor cause the leaf node to perform the following:
receive a Protocol-Independent Multicast (PIM) Join message from a node outside the MPLS core network, wherein the PIM Join message comprises a source VPN identifier (ID); and
propagate the source VPN ID across a P2MP Label Switched Path (LSP) established in the MPLS core network with in-band signaling using Resource Reservation Protocol-Traffic Engineering (RSVP-TE).

9. The computer program product of claim 8, wherein the network node encodes the source VPN ID in a PATH message that is forwarded to a root node in the MPLS core network.

10. The computer program product of claim 9, wherein the source VPN ID is encoded in a P2MP ID field or a tunnel ID field in the PATH message.

11. The computer program product of claim 8, wherein the PIM Join message further comprises a group ID that is propagated across the P2MP LSP established in the MPLS core network with in-band signaling using RSVP-TE.

12. The computer program product of claim 8, wherein the PIM Join message further comprises a rendezvous point (RP) ID that is propagated across the P2MP LSP established in the MPLS core network with in-band signaling using RSVP-TE.

13. The computer program product of claim 8, further comprising instructions stored in the non-transitory computer readable medium that when executed by the processor causes the leaf node to receive a RESV message forwarded from a root node in the MPLS core network, wherein the RESV message comprises the source ID and an upstream label assigned by the root node.

14. The computer program product of claim 8, wherein the PATH message comprises a downstream label assigned by the network node.

15. A network node that is part of a Label Switched Path (LSP) in a Multiprotocol Label Switching (MPLS) core network, comprising:
a receiver configured to receive a Protocol-Independent Multicast (PIM) Join message from a node outside the MPLS core network, wherein the PIM message comprises a source VPN identifier (ID);
a transmitter configured to transmit data to other nodes in the MPLS core network; and
a processor coupled to the receiver and the transmitter, wherein the processor is configured to create extract the source VPN ID from the PIM Join message and cause the transmitter to propagate the source VPN ID across a P2MP LSP established in the MPLS core network with in-band signaling using Resource Reservation Protocol-Traffic Engineering (RSVP-TE).

16. The network node of claim 15, wherein the processor is configured to encode the source VPN ID in a PATH message and wherein the processor is configured to cause the transmitter to forward the PATH message to a root node in the MPLS core network.

17. The network node of claim 15, wherein the source VPN ID is encoded in a P2MP ID field or a tunnel ID field in the PATH message.

18. The network node of claim 15, wherein the PIM Join message further comprises a group ID or a rendezvous point (RP) ID, wherein the processor is further configured to encode the group ID or the RP ID in the PATH message.

19. The network node of claim 15, wherein the receiver is further configured to receive a RESV message forwarded from a root node in the MPLS core network, wherein the RESV message comprises the source ID and an upstream label assigned by the root node.

20. The network node of claim 15 further comprising a binding table that stores the source VPN ID.
